(19) United States
(12) Patent Application Publication
(10) Pub. No.: US 2009/0251390 A1
(43) Pub. Date: Oct. 8, 2009

(54) PLASMA DISPLAY DEVICE

(75) Inventors: Masafumi Kumoi, Osaka (JP); Hirotsugu Fusayasu, Kyoto (JP); Hiroshi Kunimoto, Osaka (JP); Kei Ichikawa, Osaka (JP); Shouichi Mimura, Osaka (JP); Ryo Matsubara, Osaka (JP); Masato Tobinaga, Hyogo (JP); Toshiyuki Nakaie, Osaka (JP)

Correspondence Address: PANASONIC PATENT CENTER, 1130 CONNECTICUT AVENUE NW, SUITE 1100, WASHINGTON, DC, 20036, US

(73) Assignee: PANASONIC CORPORATION, Osaka (JP)

(21) Appl. No.: 12/404,393

(22) Filed: Mar. 16, 2009

(30) Foreign Application Priority Data
Apr. 2, 2008 (JP) 2008-095618

(51) Int. Cl. G09G 3/28

(52) U.S. Cl. 345/60

(57) ABSTRACT

A plasma display device including a plasma display panel having electrodes through which a driving current flows; a chassis conductor holding the plasma display panel and provided with a return circuit of the driving current; a conductive case enclosing the plasma display panel and the chassis conductor; and a binding portion for binding the chassis conductor and the conductive case to each other and having a connection state different depending upon a frequency of flowing current. The binding portion has a connection state in which an amount of flowing current is less than a half of that in a short-circuited state and a connection state in which the amount is not less than a half of that in a short-circuited state.

### BACKGROUND

1. Technical Field

The technical field relates to a plasma display device that is known as a thin large-screen display device.

2. Background Art

Spontaneous light-emitting type display devices such as a plasma display device and a CRT display (Cathode-Ray Tube display) device are widely used since they do not have a viewing angle dependency and can display natural images. In particular, a plasma display device is thin and suitable for forming a large screen, and therefore is rapidly becoming widespread.

A plasma display device mainly includes a plasma display module having a plasma display panel and a conductive case surrounding and shielding the module.

This plasma display panel excites a phosphor provided in each discharge cell by an ultraviolet ray generated by gas discharge so as to emit visible light as display light. The plasma display panel includes a plurality of display electrode pairs and address electrodes, which are arranged in a lattice. The plasma display panel forms an image by emitting light selectively in a discharge cell that is an intersection portion of the electrodes. With this principle, since large driving current flows in electrodes, an electromagnetic field is generated from a plasma display module due to this current.

Therefore, the plasma display device has a configuration in which a conductive case for shielding a generated electromagnetic field is formed, for example, by coupling a front glass to which a conductive filter is attached and a conductive back cover of the rear surface side to each other by using a conductive member to surround a plasma display module. With such a configuration, a generated electromagnetic field is electromagnetically shielded.

However, with the increase in driving electric power due to recent improvements in image quality, it has been difficult to reliably reduce an electromagnetic field by a conventional shield configuration. In particular, in low-frequency regions of not higher than several tens MHz, such an electromagnetic field cannot be sufficiently reduced by a conventional shield and may be radiated to the outside as a noise.

In order to solve such a problem, Japanese Patent Unexamined Publication No. 2001-83909 discloses a configuration in which an adjacent conductive cylinder is provided on a ground-return conductor plate for connecting between a driving substrate provided at one end of the plasma display device and a driving substrate provided at the other end of the plasma display device. Thus, it proposes a plasma display device designed to cancel the inductance of the ground-return conductive plate by an eddy current generated in this adjacent conductive cylinder.

Furthermore, Japanese Patent Unexamined Publication No. H10-282896 proposes a plasma display device having a configuration in which a chassis conductor holding a plasma display panel is coupled to a back cover and surrounds and shields a drive circuit board. It also proposes a configuration of forming a low-pass filter by the output impedance and a feed-through capacitor of a drive circuit and releasing high frequency noise components transmitted from the drive circuit to the panel by way of capacitance to the ground.

Furthermore, Japanese Patent Unexamined Publication No. 2005-221797 proposes a plasma display device in which a closed electric current path between a driving source and a load circuit forms at least two loop-structured circuits, so that the magnetic field generated in each loop-structured circuits is cancelled by each other.

However, in the plasma display device described in Japanese Patent Unexamined Publication No. 2001-83909, when the adjacent conductive cylinder having a size that can be expected to have a reducing effect is inserted inside the plasma display panel and the ground-return conductor plate, an entire area of the loop of an electric current that is a generating source of an electromagnetic field is enlarged. As a result, electromagnetic fields to be reduced are increased, thus deteriorating the effect of reducing electromagnetic fields.

Furthermore, in the plasma display device described in Japanese Patent Unexamined Publication No. H10-282896, the shielding effect of the drive circuit board itself is increased. However, an electromagnetic field generated by an electric current flowing between the plasma display panel and the chassis conductor cannot be reduced sufficiently. Furthermore, in the plasma display device described in Japanese Patent Unexamined Publication No. H10-282896, since a filter is directly formed on a load of the drive circuit, a driving waveform is largely affected thereby and light emission of the panel itself becomes insufficient. Therefore, there is a trade off between the reducing effect by the filter and the stability of light emission of the panel. The end result is that the effect of reducing an electromagnetic field cannot be obtained sufficiently.

Furthermore, in the plasma display device described in Japanese Patent Unexamined Publication No. 2005-221797, since a driving current path itself is extended, it is necessary to adjust a drive signal waveform and the like. Furthermore, since it is difficult to completely cancel electromagnetic fields generated in the two loop structures, it is difficult to achieve a sufficient reducing effect.

### SUMMARY

A plasma display device includes a plasma display panel having electrodes through which a driving current flows; a chassis conductor holding the plasma display panel and provided with a return circuit of the driving current; a conductive case enclosing the plasma display panel and the chassis conductor; and a binding portion for binding the chassis conductor and the conductive case to each other and having a connection state different depending upon a frequency of flowing current. The binding portion has a connection state in which an amount of flowing current is less than a half of that in a short-circuited state and a connection state in which the amount is not less than a half of that in a short-circuited state.

With such a configuration, it is possible to efficiently reduce an electromagnetic noise caused by a driving current flowing in the plasma display panel.

### BRIEF DESCRIPTION OF THE DRAWINGS

FIG. 1A is a front schematic view illustrating a configuration of a plasma display device in accordance with a first embodiment.

FIG. 1B is a schematic view of a section taken along line 1B-1B of FIG. 1A.

FIG. 2 is a perspective view illustrating a configuration of a plasma display module in the plasma display device in accordance with the first embodiment.

FIG. 3A is a perspective view illustrating an electrode structure of a plasma display panel in the plasma display device in accordance with the first embodiment.

FIG. 3B is a sectional view illustrating an electrode structure of a plasma display panel in the plasma display device in accordance with the first embodiment.

FIG. 4 is a perspective view illustrating a structure of a conductive front filter in the plasma display device in accordance with the first embodiment.

FIG. 5A is a schematic view illustrating a relation between a chassis conductor and a glass pressing metal and first and second binding portions in the plasma display device in accordance with the first embodiment.

FIG. 5B is an enlarged view showing the first and second binding portions in the plasma display device in accordance with the first embodiment.

FIG. 6A is a schematic view illustrating a relation between a chassis conductor and a glass pressing metal and first and second binding portions in another example in the plasma display device in accordance with the first embodiment.

FIG. 6B is an enlarged view showing the first and second binding portions in another example in the plasma display device in accordance with the first embodiment.

FIG. 7 is a conceptual view illustrating a principle in which an interfering electromagnetic wave due to a panel driving current is reduced.

FIG. 8 is an exploded perspective view illustrating that a short-ring function is formed in the plasma display device in accordance with the first embodiment.

FIG. 9 is a graph illustrating a relation between a current flowing in the first and second binding portions and a frequency.

FIG. 10A is a schematic view illustrating a relation between a chassis conductor and a glass pressing metal and first and second binding portions in the plasma display device in accordance with a second embodiment.

FIG. 10B is an enlarged view showing the first and second binding portions in the plasma display device in accordance with the second embodiment.

FIG. 11A is a schematic view illustrating a relation between a chassis conductor and a glass pressing metal and binding portions in accordance with a third embodiment.

FIG. 11B is an enlarged view showing the binding portion in the plasma display device in accordance with the third embodiment.

### DETAILED DESCRIPTION OF PREFERRED EMBODIMENT

Hereinafter, various embodiments associated with a plasma display device are described with reference to drawings.

### First Embodiment

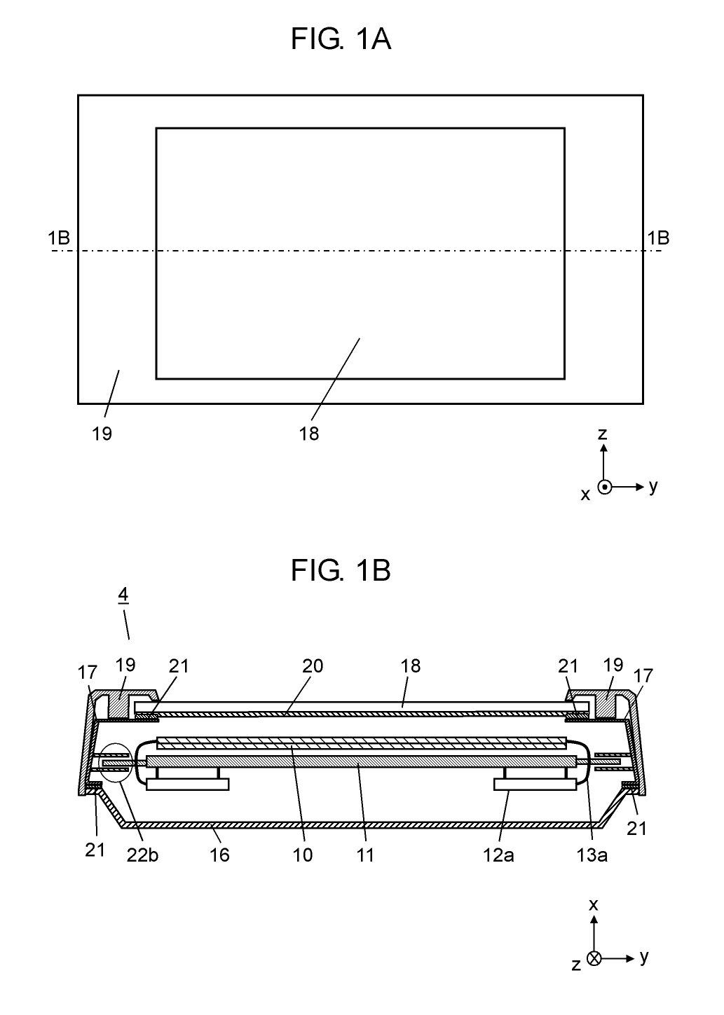

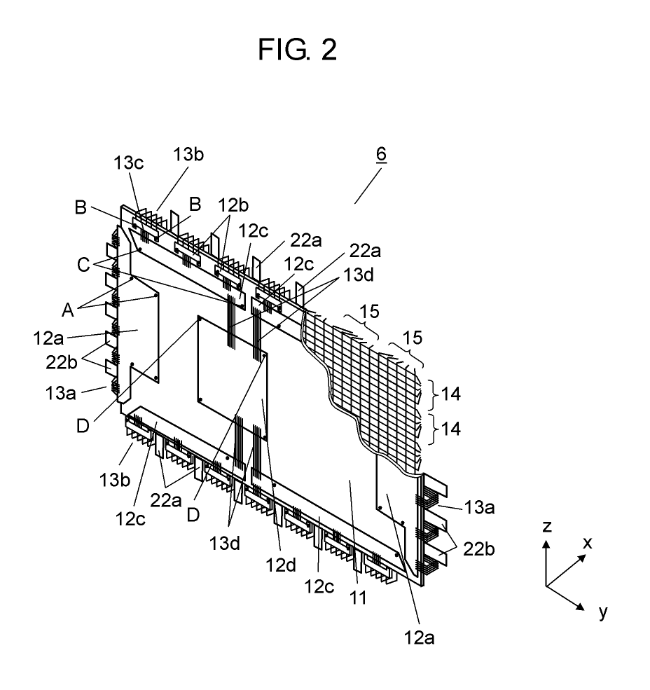

Firstly, a structure of a plasma display device in accordance with a first embodiment is described. FIGS. 1A to 6 show plasma display device 4 in accordance with the first embodiment. FIG. 1A is a front view illustrating a configuration of plasma display device 4 in accordance with the first embodiment. FIG. 1B is a schematic view of a section taken along line 1B-1B of FIG. 1A. These figures show only the structures deeply related to radiation of undesirable electromagnetic waves in plasma display device 4 in accordance with the first embodiment. FIG. 2 is a perspective view illustrating a configuration of plasma display module 6 of plasma display device 4 in accordance with the first embodiment.

Hereinafter, for the sake of convenience, a normal direction of a display surface of plasma display device 4 is also referred to as an x-axis, a longitudinal direction of a display surface of plasma display device 4 is also referred to as a y-axis, and a direction orthogonal to the x-axis and y-axis is also referred to as a z-axis.

In FIGS. 1A, 1B and 2, plasma display module 6 of plasma display device 4 in accordance with the first embodiment includes plasma display panel 10 having a plurality of scan-sustain electrodes 14 that are electrodes parallel to each other and through which a driving current flows in the longitudinal direction and address electrodes 15 that are parallel to each other in the short direction. Furthermore, chassis conductor 11 holding plasma display panel 10 and being provided with a return circuit of the driving current is disposed at the opposite side to the display surface of plasma display panel 10 via a thermal conductive sheet (not shown).

Firstly, with reference to FIG. 1B, a configuration of a conductive case is described. At the outside of plasma display module 6, back cover 16, glass pressing metal 17, front glass 18, front cabinet 19, conductive front filter 20, and conductive gasket 21 are provided in a way in which they enclose plasma display module 6. Among them, back cover 16, glass pressing metal 17, conductive front filter 20 attached to front glass 18 and conductive gasket 21 constitute a conductive case. That is to say, the conductive case encloses plasma display panel 10 and chassis conductor 11.

Next, with reference to FIG. 2, a configuration for driving scan-sustain electrodes 14 and address electrode 15 is described. Scan-sustain electrodes drive circuit board 12a, address electrode drive circuit board 12b, junction circuit substrate 12c, and discharge control circuit board 12d are disposed at a rear surface side of chassis conductor 11.

In order to drive scan-sustain electrodes 14, a driving signal generated from scan-sustain electrodes drive circuit board 12a is transmitted to scan-sustain electrodes 14 of plasma display panel 10 by flexible cable 13a.

In order to drive address electrode 15, firstly, a high frequency signal generated in discharge control circuit board 12d is transmitted to junction circuit substrate 12c by flexible cable 13d. Next, the high frequency signal is transmitted to address electrode drive circuit board 12b by flexible cable 13c. Then, a driving signal is generated in address electrode drive circuit board 12b and transmitted to address electrode 15 of plasma display panel 10 by flexible cable 13b.

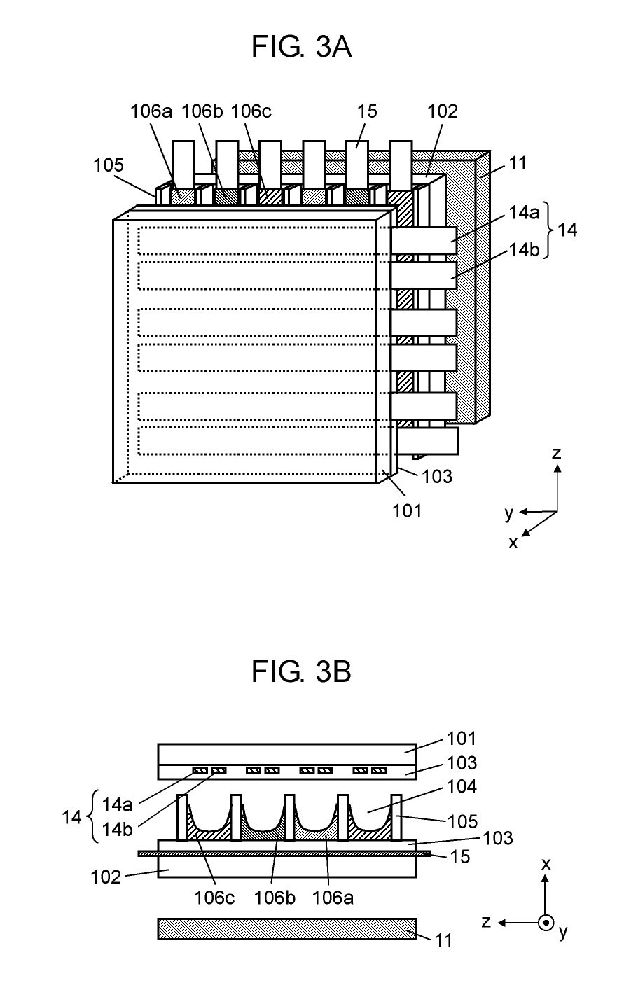

FIG. 3A is a perspective view illustrating an electrode structure of plasma display panel 10 in plasma display device 4 in accordance with the first embodiment. FIG. 3B is a sectional view thereof. As shown in FIGS. 3A and 3B, plasma display panel 10 has a structure in which front glass plate 101 and rear glass plate 102 are attached to each other. On front glass plate 101, dielectric layer 103 is formed. A large number of scan-sustain electrodes 14 each consisting of scan electrode 14a and sustain electrode 14b are formed in a way in which they are protected by dielectric layer 103. Dielectric layer 103 is formed also on rear glass plate 102. Similarly, a large number of address electrodes 15 are formed in a way in which they are protected by dielectric layer 103.

A portion that is a crossing position of scan-sustain electrodes 14 and address electrode 15 and that is sandwiched by scan-sustain electrodes 14 and address electrode 15 is discharge cell 104. Discharge cell 104 is filled with a discharge gas including a noble gas such as helium (He), neon (Ne) and xenon (Xe). Discharge cells 104 are divided by barrier ribs 105. Each discharge cell 104 includes red phosphors 106a, blue phosphors 106b and green phosphors 106c, which are colored differently.

Chassis conductor 11 is made of a plate of metal such as aluminum and copper having high thermal conductivity and electrical conductivity. Plasma display panel 10 is attached to a front surface that is one of the surfaces of chassis conductor 11 via a thermal conductive sheet. Furthermore, drive circuit boards and the like are attached to a rear surface that is the other surface of chassis conductor 11. Drive circuit boards and the like are attached in parallel to chassis conductor 11. Chassis conductor 11 is coupled to a ground of each drive circuit board and the like.

Chassis conductor 11 holds plasma display panel 10 and drive circuit boards and the like, and functions as a reinforcing member for maintaining the strength thereof. Also, chassis conductor 11, as an electrical ground of each drive circuit board, functions as a current return circuit of the above-mentioned driving signal. As shown in FIG. 2, for example, a signal ground of scan-sustain electrodes drive circuit board 12a is point A, a signal ground of address electrode drive circuit board 12b is point B, a signal ground of junction circuit substrate 12c is point C, and a signal ground of discharge control circuit board 12d is point D. Each signal ground is grounded on chassis conductor 11 that is a frame ground.

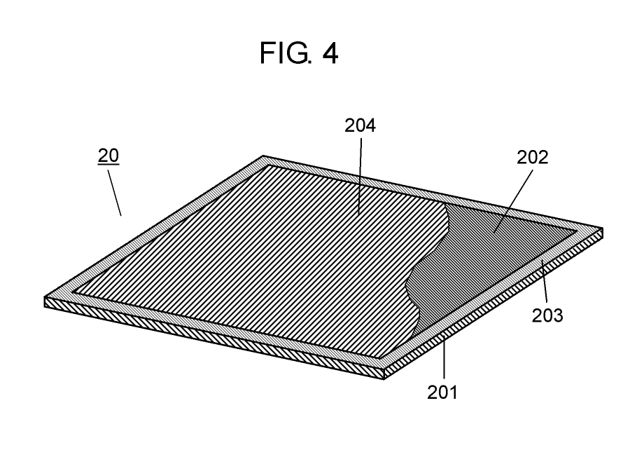

FIG. 4 is a perspective view illustrating a structure of conductive front filter 20 in plasma display device 4 in accordance with the first embodiment. As shown in FIG. 4, conductive front filter 20 includes base layer 201, conductive layer 202, metal end portion 203 and protective film 204. Base layer 201 is made of, for example, polyester film. Conductive layer 202 is formed on base layer 201 by formation of metal mesh such as copper, or by sputter formation. Metal end portion 203 has a metal foil shape and is formed on the peripheral portion of conductive layer 202. Protective film 204 is formed of a transparent insulating resin on conductive layer 202. Since metal end portion 203 is not covered with protective film 204, it functions as an electric connection portion.

Note here that conductive layer 202 is formed by using, for example, a copper mesh as a metal mesh, and by silver sputtering as sputtering. When the metal mesh is used, a higher shielding effect can be obtained because the resistivity is low.

As shown in FIG. 1B, front glass 18 is disposed at the front surface side of plasma display panel 10. Conductive front filter 20 is attached to the rear surface of front glass 18, that is, at the side opposite to the display surface. Front glass 18 functions as protecting the display surface from shock.

Glass pressing metal 17 fixes front glass 18 by sandwiching front glass 18 between glass pressing metal 17 and front cabinet 19. Glass pressing metal 17 is disposed in a way in which it is brought into electrical contact with metal end portion 203 of conductive front filter 20 attached to front glass 18 via conductive gasket 21 that is a conductive contacting member. Furthermore, glass pressing metal 17 is also brought into contact with back cover 16 via conductive gasket 21.

Note here that conductive gasket 21 is made by, for example, attaching metal fiber to an elastic material like a sponge. Herein, as a conductive contacting member, conductive gasket 21 is used but the member is not necessarily limited to this. That is to say, any members having an electrical conductivity and securing stability in electrical contact between two members may be used. For example, glass pressing metal 17 may be provided with a conductive spring portion. In this case, the cost can be lowered.

Back cover 16 is formed by press molding a conductive metal plate. Back cover 16 is fixed to glass pressing metal 17 so as to cover the rear surface of plasma display panel 10 and drive circuit boards, and the like. Back cover 16 plays a role of shielding electromagnetic waves radiated from plasma display panel 10 and drive circuit boards, and the like. Back cover 16 together with conductive front filter 20, conductive gasket 21 and glass pressing metal 17 forms a conductive case. The conductive case encloses plasma display panel 10 and chassis conductor 11.

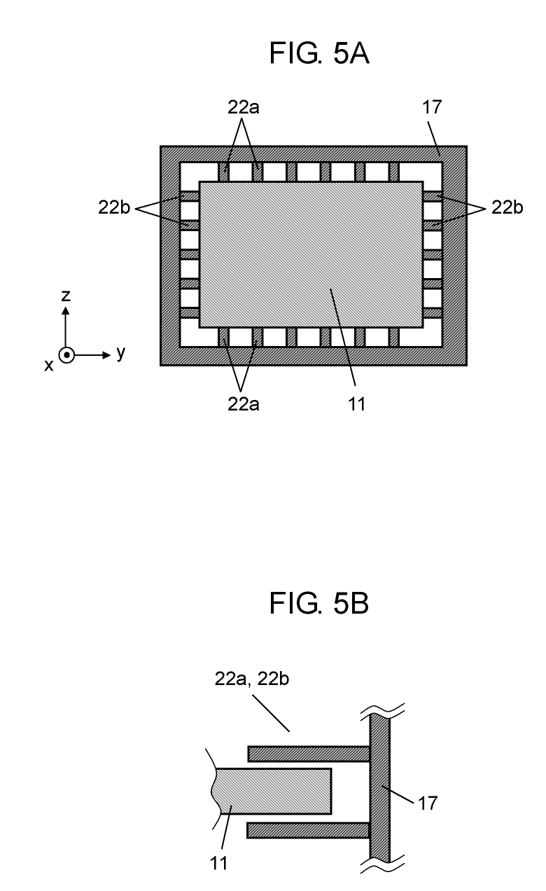

FIG. 5A is a schematic view illustrating a relation between chassis conductor 11 and glass pressing metal 17 and first binding portion 22a and second binding portion 22b. As shown in FIG. 5A, between chassis conductor 11 and glass pressing metal 17, first and second binding portions 22a and 22b are provided. First binding portions 22a are provided on the edge side parallel to the direction of scan-sustain electrodes 14, that is, in the longitudinal direction of chassis conductor 11 in this embodiment. Second binding portions 22b are provided on the edge side perpendicular to the direction of scan-sustain electrodes 14, that is, in the shorter direction of chassis conductor 11 in this embodiment. Herein, the binding denotes a conception including not only physical binding but also electrically binding.

FIG. 5B is an enlarged view showing first binding portion 22a and second binding portion 22b in the plasma display device in accordance with the first embodiment. As shown in FIG. 5B, in the binding portion including first binding portion 22a and second binding portion 22b, glass pressing metal 17 has a concave shape. A part of chassis conductor 11 is disposed in the concave shape of first binding portion 22a and second binding portion 22b in a state in which they are not brought into contact with each other. At this time, chassis conductor 11 and glass pressing metal 17 face each other in a predetermined area. Therefore, they are electrically coupled to each other and function as a capacitor.

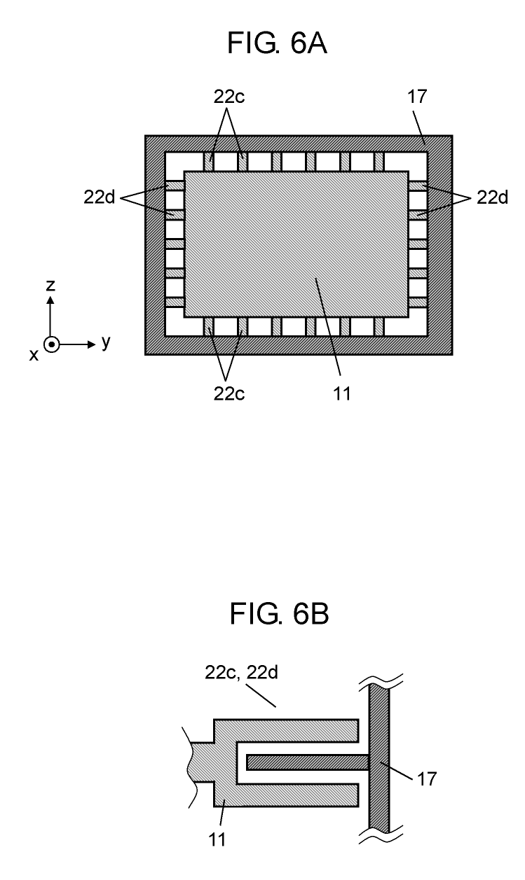

In FIG. 5B, glass pressing metal 17 has a concave shape, but the shape is not necessarily limited to this. FIG. 6A is a schematic view illustrating a relation between chassis conductor 11 and glass pressing metal 17 and first binding portion 22c and second binding portion 22d in another example in plasma display device 4 in accordance with the first embodiment. FIG. 6B is an enlarged view showing first binding portion 22c and second binding portion 22d in another example in the plasma display device 4 in accordance with the first embodiment. That is to say, as shown in FIG. 6B, a configuration, in which chassis conductor 11 has a concave shape and a part of glass pressing metal 17 is disposed in the concave shape of chassis conductor 11 in a way in which they are not brought into contact with each other, may be employed.

As mentioned above, the binding portion of the plasma display device may be formed of a part of chassis conductor 11 and glass pressing metal 17 in which one is provided with a concave portion and the other is disposed in the concave portion.

When a capacitor is formed in this way, it is possible to easily realize a configuration in which in a low frequency region, a current does not easily flow, and as the frequency is increased, a resistance value is reduced and thus current flows. Note here that the configuration of the capacitor is not necessarily limited to this. Other methods may be employed as long as glass pressing metal 17 and a part of chassis conductor 11 can realize a function of capacitor. For example, instead of forming a concave shape, a configuration in which planes face each other may be employed. In this case, the cost can be reduced and assembly becomes easy. When a concave shape is employed, a facing area can be increased in limited space.

Next, in plasma display device 4 in accordance with this embodiment, the principle and operation in which undesirable radiation of interfering electromagnetic wave due to a driving current is reduced are described based on the operation principle of a plasma display panel.

Firstly, the image display principle of plasma display panel 10 is described with reference to FIG. 2. Firstly, a voltage is applied to all lines of scan electrode 14a so as to carry out initializing discharge causing discharge in all discharge cells 104. Next, a voltage is sequentially applied to scan electrode 14a and a voltage is also applied to address electrode 15 that intersects with discharge cell 104 to emit light on scan electrode 14a to which a voltage is applied. This is called address discharge, and discharge cell 104 in a position where scan electrode 14a to which a voltage is applied and address electrode 15 intersect with each other emits light, and this discharge cell 104 is selected as a light emission cell. Thereafter, sustain discharge in which an AC voltage is applied between scan electrode 14a and sustain electrode 14b is carried out. The applied voltage in the sustain discharge uses square wave of 180 kHz that is a fundamental frequency. By sustain discharge, only a light emitting cell selected previously emits light, and plasma display panel 10 displays an image. Herein, a current flowing into electrodes by address discharge or sustain discharge is referred to as a driving current.

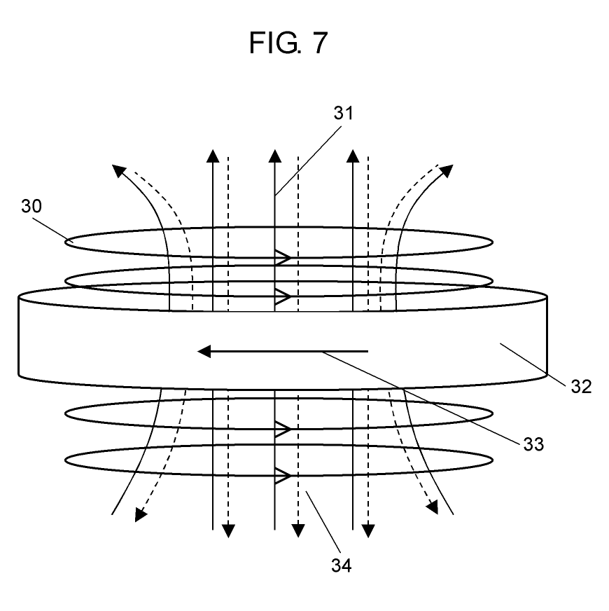

Next, the principle and operation in which interfering electromagnetic waves due to a driving current is reduced are described with reference to FIG.7. FIG. 7 is a view showing a principle in which interfering electromagnetic waves due to a driving current are reduced.

In general, when loop current 30 flows, a strong generated magnetic field 31 is generated by Ampere's rule in the direction perpendicular to a plane on which this loop is formed. When ring-shaped conductor 32 is placed in a position encompassing loop current 30, a counter electromotive force is generated on this conductor due to the electromagnetic induction effect. Then, induced current 33 in the reverse direction to the original loop current 30 is induced in ring-shaped conductor 32. This ring-shaped conductor 32 is referred to as a short ring. This generated magnetic field 34 by induced current 33 is generated in the reverse direction with respect to generated magnetic field 31 by loop current 30, thus exhibiting an effect of cancelling original generated magnetic field 31.

The above-mentioned principle is described by applying it to the configuration of FIGS. 1A-1B. Firstly, sustain discharge is described. A driving current of signal of 180 kHz that is a fundamental frequency driven from scan-sustain electrodes drive circuit board 12a flows in flexible cable 13a and scan-sustain electrodes 14 of plasma display panel 10 and chassis conductor 11 and flows in a loop shape substantially in parallel to the x-y plane. Furthermore, the loop-shaped driving current generates a magnetic field in the vertical direction (in the direction parallel to the z direction in FIGS. 1A and 1B) according to the Ampere's rule.

Similarly, the address discharge is described. A driving current flows in flexible cable 13b, address electrode 15 of plasma display panel 10 and chassis conductor 11, and flows in a loop shape substantially in parallel to the z-x plane. Furthermore, the loop-shaped driving current generates a magnetic field in the horizontal direction (in the direction parallel to the y direction in FIGS. 1A and 1B) according to the Ampere's rule.

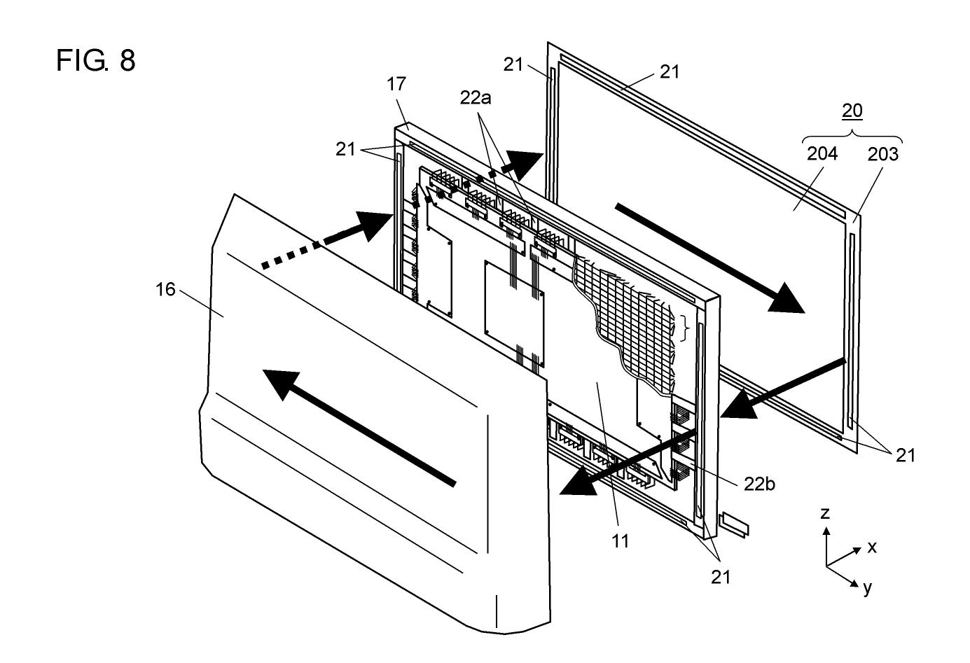

FIG. 8 is an exploded perspective view illustrating that the above-mentioned short-ring function is formed in plasma display device 4 in accordance with the first embodiment. As shown in FIG. 8, when both first binding portions 22a, 22c and second binding portions 22b, 22d are in an insulating state (open state), a shield case including conductive front filter 20, conductive gasket 21, glass pressing metal 17 and back cover 16 is separated from chassis conductor 11. Furthermore, the loop shape in the section (x-y plane) in the horizontal direction of the shield case is substantially in parallel to the loop of the driving current at the time of sustain discharge in plasma display module 6. Furthermore, the loop shape in the section (z-x plane) of the vertical direction of the shield case is substantially in parallel to the loop of the driving current at the time of address discharge in plasma display module 6. Therefore, according to the above-mentioned principle, a loop current in the reverse direction to the driving current is excited on the loop including conductive front filter 20, conductive gasket 21, glass pressing metal 17 and back cover 16 so as to cancel a magnetic field generated from plasma display module 6. An arrow in FIG. 8 shows a loop current excited at the time of sustain discharge.

Thus, with the configuration in which both first binding portions 22a, 22c and second binding portions 22b, 22d are in an insulating state, the shield case plays a role of a short ring with respect to a magnetic field generated by a loop of a driving current. Thus, an effect of cancelling a magnetic field can be achieved, and as a result, a large effect of reducing a noise can be achieved.

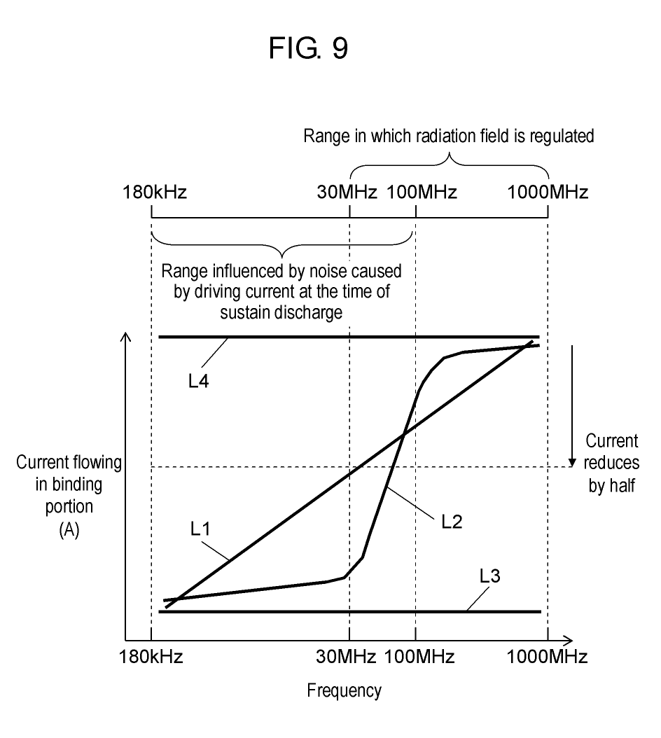

FIG. 9 is a graph illustrating a relation between a current flowing in first binding portions 22a, 22c and second binding portions 22b, 22d and a frequency associated with the driving current. In this embodiment, first binding portions 22a, 22c and second binding portions 22b, 22d have a property shown by L1 in FIG. 9. That is to say, a binding portion including first binding portions 22a, 22c and second binding portions 22b, 22d allows chassis conductor 11 and the conductive case to be bonded with each other and has a connection state that is different depending upon the frequency of flowing current. That is to say, first binding portions 22a, 22c and second binding portions 22b, 22d have a connection state in which the amount of flowing current becomes less than half that of the current flow in a short-circuited state and a connection state in which the amount is greater than or equal to half of the current flow in the short-circuited state. In other words, they have a connection state in which the amount of flowing current is near the open state rather than the short-circuited state and a connection state in which the amount is near the short-circuited state rather than the open state. In particular, first binding portions 22a, 22c and second binding portions 22b, 22d are designed to be substantially the open state at least in 180 kHz that is a fundamental frequency of the driving current in the sustain discharge. Furthermore, they are designed to be substantially in the short-circuited state at least in 1 GHz that is an upper limit of a legal standard of radiation field regulated by International Standard of electromagnetic interference by CISPR (International Special Committee on Radio), Electrical Appliance and Material Safety Law of Japan, and the like. That is to say, it is desirable that the binding portion is in a connection state in which the amount of flowing current is less than half of that in the short-circuited state in the fundamental frequency of the driving current, and a connection state in which the amount is greater than or equal to half of that in the short-circuited state in 1 GHz.

Note here that in FIG. 9, L3 represents an open state; L4 represents a short-circuited state. The frequency of a connection state in which the amount of flowing current is less than half of that in the short-circuited state or the frequency of a connection state in which the amount is greater than or equal to half of that in the short-circuited state are decided by capacitance determined by a facing area and a distance of chassis conductor 11 and glass pressing metal 17. Therefore, they can be adjusted to arbitrary values.

As mentioned above, the driving current is applied at the fundamental frequency of 180 kHz in the sustain discharge. However, because the driving current is a square wave, it may have higher harmonic waves which affect the noise. Particularly, the driving current generates a large noise particularly in a frequency region of about than 10 MHz or less due to the influence of the higher harmonic waves. Furthermore, depending upon specific design specifications, influence of this noise may occur in the frequency region of up to about 100 MHz. Therefore, in order to reduce it efficiently, it is preferable that first binding portions 22a, 22c and second binding portions 22b, 22d are set to be in a connection state that is near an open state rather than a short-circuited state for 100 MHz or less.

Furthermore, a lower limit of the legal standard of radiation field regulated by International Standard of electromagnetic interference by CISPR, Electrical Appliance and Material Safety Law of Japan and the like is 30 MHz. In the frequency region of 30 MHz or greater, generation of noise from a signal processing circuit (not shown) generating high frequency noise components becomes remarkable. In order to reduce noise from such a signal processing circuit, it is desirable that the ground of the circuit is stable in low impedance. Chassis conductor 11 functions as a ground of the printed board of such circuits. Therefore, it is not preferable that first binding portions 22a, 22c and second binding portions 22b, 22d are insulated in this case. Thus, in the frequency region of not less than 30 MHz, it is preferable that low impedance is achieved by increasing electrical connections as many as possible. That is to say, it is preferable that first binding portions 22a, 22c and second binding portions 22b, 22d are set to be in a connection state that is near a short-circuited state rather than an open state in greater than or equal to 30 MHz.

From the viewpoint of both noise caused by a driving current and noise caused by a signal processing circuit, as shown by L1 in FIG. 9, it is preferable that a cutoff frequency of the binding portion, that is, a boundary frequency in which a connection state in which the amount of flowing current is less than half of that in the short-circuited state to a connection state in which the amount greater than or equal to half of that in the short-circuited state, is set between 30 and 100 MHz. Thus, it is possible to efficiently reduce a noise due to a driving current of the panel without deteriorating the noise property caused by the signal processing circuit. Consequently, both effects can be obtained.

Note here that these frequencies are not necessarily limited to this range. The frequency can be appropriately set to an optimum value by the degree of influence of noise caused by the driving current of the panel and the degree of influence of noise caused by the signal processing circuit. For example, when noise caused by the signal processing circuit is large around 30 MHz, the cutoff frequency may be set between 10 and 30 MHz. Thus, in a range less than 10 MHz in which noise due to the driving current of the panel is large, a short-ring effect is secured while a low impedance effect of chassis conductor 11 around 30 MHz can be secured.

### Second Embodiment

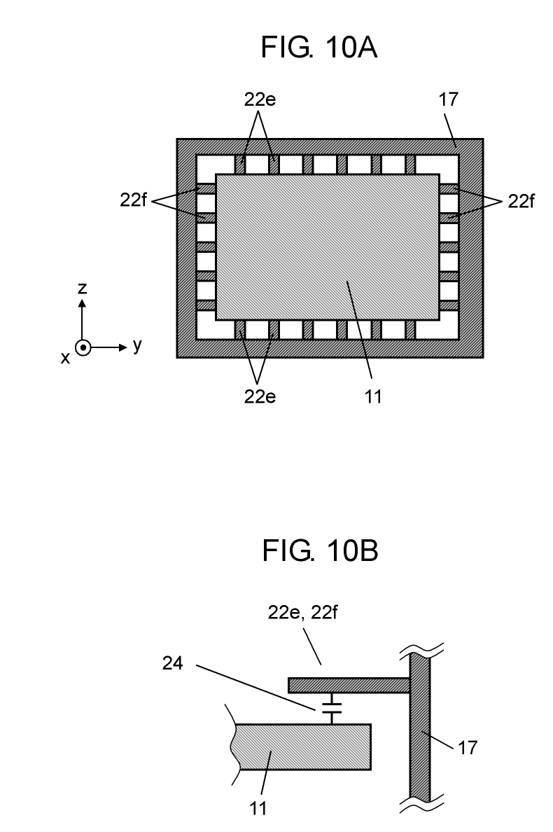

Next, a plasma display device in accordance with a second embodiment is described. FIG. 10A is a schematic view illustrating a relation between chassis conductor 11 and glass pressing metal 17 and first binding portion 22e and second binding portion 22f in plasma display device 4 in accordance with the second embodiment. Plasma display device 4 of this embodiment is described with reference to FIGS. 10A and 10B. Note here that the same reference numerals are given to the same configuration as in the first embodiment and detailed description thereof is omitted.

The configuration of FIG. 10A is the same as the above-mentioned configuration of FIG. 5A except for first binding portion 22e and second binding portion 22f. FIG. 10B is an enlarged view showing the configuration of first binding portion 22e and second binding portion 22f by enlarging the binding portion between glass pressing metal 17 and chassis conductor 11. The second embodiment is different from the first embodiment in the structure of the binding portion.

In the second embodiment, first binding portion 22e and second binding portion 22f are formed by using capacitor 24 between glass pressing metal 17 and chassis conductor 11. That is to say, in the binding portion of the plasma display device, a part of chassis conductor 11 is allowed to face glass pressing metal 17 as a part of the conductive case and capacitor 24 is formed. With such a configuration, a capacitance value can be set without the need to calculate a facing area, and the like.

Note here that in this modified embodiment, capacitor 24 is used. However, the configuration is not necessarily limited to this. That is to say, any other configurations can be employed as long as they include a filter function having a connection state in which the amount of flowing current becomes less than or equal to half of that in a short-circuited state and a connection state in which the amount of flowing current becomes greater than or equal toe half of that in a short-circuited state depending upon noises. For example, as shown by L2 in FIG. 9, a high pass filter of an RC circuit having a cutoff frequency in not less than 30 MHz and not more than 100 MHz may be used. Furthermore, a band pass filter having a property of allowing frequencies between 30 and 100 MHz may be used.

### Third Embodiment

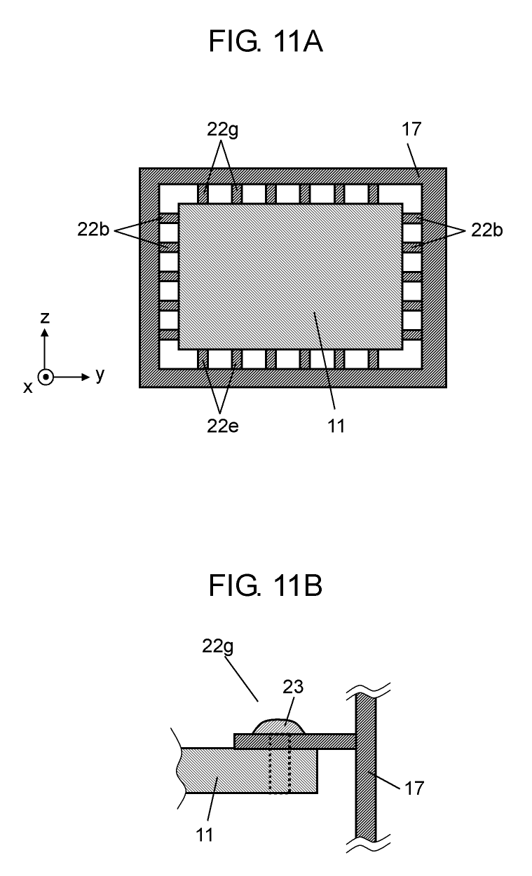

Next, a plasma display device in accordance with a third embodiment is described. FIG. 11A is a schematic view illustrating a relation between chassis conductor 11 and glass pressing metal 17 and binding portions in plasma display device 4 in accordance with the third embodiment. Plasma display device 4 in the third embodiment is described with reference to FIGS. 11A and 11B. Note here that the same reference numerals are given to the same configuration as in the first embodiment and detailed description thereof is omitted.

In the first embodiment, plasma display device 4 is configured by using first binding portion 22a. However, the third embodiment is different in that first binding portion 22g is used. Furthermore, second binding portion 22b is used as in the first embodiment.

In this embodiment, as shown in FIG. 11A, instead of first binding portion 22a of the first embodiment, first binding portion 22g is used. As shown in FIG. 11B, first binding portion 22g is coupled and fixed by screw 23. That is to say, this embodiment is not provided with a function of capacitance as in the first embodiment.

Firstly, the role of second binding portion 22b is described. As mentioned above, a driving current at the time of sustain discharge flows in chassis conductor 11 and scan electrode 14a and sustain electrode 14b that are parallel to the longitudinal direction of chassis conductor 11. That is to say, a driving current forms a loop parallel to the x-y plane of FIG. 11A. For forming a short ring to this loop, a connection state of right and left edges of chassis conductor 11, that is, second binding portion 22b may be in a connection state near an open state. Thus, a shield case including conductive front filter 20, conductive gasket 21, glass pressing metal 17 and back cover 16 can be provided with a short-ring function.

With such a configuration, similar to the first embodiment, second binding portion 22b is allowed to have a cutoff frequency in the range of between 30 and 100 MHz, thereby realizing a short-ring function in the x-y plane.

However, first binding portion 22g is firmly fixed by screw 23 and electrically coupled. Therefore, a connection state is a short-circuited state in any frequencies, and a short ring is not formed in the z-x plane. The reason why binding portion 22g is configured in this way is described below.

In a frequency 30 MHz or greater, the generation of noise from a signal processing circuit (not shown) that generates high frequency noise components becomes remarkable. Therefore, it is not preferable that second binding portion 22b becomes in an open state. Therefore, by setting a cutoff frequency in the range of not less than 30 MHz and not more than 100 MHz, low impedance is obtained by increasing the electrical connections as many as possible.

As mentioned above, in a binding portion of plasma display device 4 of this embodiment, the edge side of chassis conductor 11 perpendicular to the direction of scan-sustain electrodes 14 in the electrodes may be fixed to the conductive case.

With such a configuration, the shield case plays a role as a short ring with respect to a magnetic field generated by a loop of a driving current at the time of sustain discharge in which a larger driving current flows as compared with the address discharge, and thus a cancelling effect is exhibited. As a result, an effect of reducing noise can be achieved. Furthermore, since first binding portion 22g is fixed by screw 23, the chassis conductor 11 can be fixed without particularly using any additional fixing methods.

Note here that the method of fixing first binding portion 22g is not necessarily limited to the method using screw 23 and any other methods may be used as long as first binding portion 22g can be stably fixed. For example, a hooked portion may be provided so that first binding portion 22g can be hooked thereon. In this method, the cost can be reduced as compared with the case where screw 23 is used.

This embodiment employs a configuration in which first binding portion 22g is formed so that only a driving current loop at the time of sustain discharge is cancelled. However, the configuration is not necessarily limited to this. For example, since a loop of current flowing in the shorter direction of the display surface (for example, the z-x plane in FIG. 8) at the time of address discharge is formed, the first binding portion may be provided with a capacitor function and the second binding portion may be fixed by a screw. Thus, it is possible to reduce only interfering electromagnetic wave accompanying the address discharge.

Furthermore, the first and second embodiments describe an embodiment in which a connection state is a state in which the amount of flowing current is less than half of that in the short-circuited state in 180 kHz that is a fundamental frequency of a driving current, and a connection state is a state in which the amount of flowing current is not less than the half of that in the short-circuited state in 1 GHz that is an upper limit of a legal standard of radiation field. However, the embodiment is not necessarily limited to this. The connection state in which the amount of flowing current is less than the half of that in the short-circuited state and the connection state in which the amount of flowing current is not less than the half of that in the short-circuited state can be set appropriately according to noises and the like. For example, when only noise around 10 MHz among noises caused by the driving current of the panel is intended to be reduced, a connection state is made to be a state in which the amount of flowing current is not more than the half of that in the short-circuited state only around 10 MHz and a connection state is made to be a state in which the amount is not less than the half of that in a short-circuited state in other frequencies.

Specific numeric values used in the first to third embodiments are just examples and can be appropriately set to optimum values according to the properties of a plasma display panel, specification of a plasma display device, and the like.

What is claimed is:

1. A plasma display device, comprising:
a plasma display panel having electrodes through which a driving current flows;
a chassis conductor holding the plasma display panel and provided with a return circuit of the driving current;
a conductive case enclosing the plasma display panel and the chassis conductor; and
a binding portion for binding the chassis conductor and the conductive case to each other and having a connection state different depending upon a frequency of flowing current,
wherein the binding portion has a connection state in which an amount of flowing current is less than half of current flow in a short-circuited state and a connection state in which the amount is not less than a half of that in the short-circuited state.

2. The plasma display device of claim 1,
wherein the binding portion is in the connection state in which the amount of flowing current is less than half of that in the short-circuited state in a fundamental frequency of the driving current, and is in the connection state in which the amount is not less than half of that in a short-circuited state in 1 GHz.

3. The plasma display device of claim 2,
wherein the binding portion has a boundary frequency at which the connection state in which the amount of flowing current is less than half of that in the short-circuited state shifts to the connection state in which the amount of flowing current is not less than a half of that in a short-circuited state in not less than 30 MHz and not more than 100 MHz.

4. The plasma display device of claim 1,
wherein the binding portion is formed by allowing a part of the chassis conductor and a part of the conductive case to face each other to provide a capacitor.

5. The plasma display device of claim 4,
wherein the binding portion is formed of the part of the chassis conductor and the part of the conductive case in which one is provided with a concave portion and an other is disposed in the concave portion.

6. The plasma display device of claim 1,
wherein the electrode includes scan-sustain electrodes, and
the binding portion fixes an edge side of the chassis conductor perpendicular to a direction of the scan-sustain electrodes in the electrodes and the conductive case to each other.

7. A plasma display device comprising:
a plasma display panel including a plurality of electrodes;
a chassis conductor holding the plasma display panel;
a plurality of driving circuits providing driving current to the electrodes, the plurality of driving circuits electrically grounded by the chassis conductor;
a conductive case enclosing the plasma display panel and the chassis conductor; and
a binding portion for binding the chassis conductor and the conductive case,
the binding portion configured to substantially limit flow current below a cutoff frequency between the chassis conductor and the conductive case, and to substantially flow current above a cutoff frequency between the chassis conductor and the conductive case.

8. The plasma display device of claim 7, wherein the binding portion is further configured to flow an amount of current below the cutoff frequency between the chassis conductor and the conductive case which is less than half of current flow in a short-circuited state, and to flow an amount of current between the chassis conductor and the conductive case above the cutoff frequency which is greater than or equal to half of the current flow in the short-circuited state.

9. The plasma display device of claim 7, wherein the cutoff frequency is equal to a value substantially between 30 and 100 MHz.

10. The plasma display device of claim 8,
wherein the electrodes include scan and sustain electrodes disposed in a first direction,
wherein the driving circuits provide the scan and sustain electrodes with a driving current during a sustain discharge state,
wherein the binding portion includes first binding portions disposed in the first direction, and
wherein when the binding portion flows the amount of current between the chassis conductor and the conductive case which is less than half of current flow in the short-circuited state during the sustain discharge state, loop currents flow in a reverse direction to the driving currents provided to the scan and sustain electrodes to substantially cancel a magnetic field generated from the plasma display panel.

11. The plasma display device of claim 10,
wherein when the binding portion is configured to flow the amount of current between the chassis conductor and the conductive case which is greater than or equal to half of current flow in the short-circuited state, noise caused by a signal processing circuit included on the plasma display device is substantially reduced.

12. The plasma display device of claim 8,
wherein the electrodes includes address electrodes disposed in a second direction,
wherein the driving circuits provide the address electrodes with a driving current during a sustain discharge state,
wherein the binding portion includes second binding portions disposed in the second direction, and
wherein when the binding portion is configured to flow the amount of current between the chassis conductor and the conductive case which is less than half of current flow in the short-circuited state during the sustain discharge state, loop currents flow in a reverse direction to the driving currents provided to the scan sustain electrodes to substantially cancel a magnetic field generated from the plasma display panel.

13. The plasma display device of claim 12,
wherein when the binding portion is configured to flow the amount of current between the chassis conductor and the conductive case which is greater than or equal to half of current flow in the short-circuited state, noise caused by a signal processing circuit included on the plasma display device is substantially reduced.

14. The plasma display device of claim 7, wherein the binding portion includes a part of the chassis conductor and a part of the conductive case facing each other to provide a capacitor.

15. The plasma display device of claim 7, wherein the binding portion includes one of a part of the chassis conductor and a part of the conductive case to be a concave portion and the other disposed in the concave portion.
